(19) United States
(12) Patent Application Publication
(10) Pub. No.: US 2005/0223098 A1
(43) Pub. Date: Oct. 6, 2005

(54) Delivery mechanism for static media objects

(75) Inventors: Ivica Rimac, Darmstadt (DE); Jose Luis Rey, Heidenreichstr (DE); Rolf Hakenberg, Schepp Allee (DE)

Correspondence Address: STEVENS DAVIS MILLER & MOSHER, LLP, 1615 L STREET, NW, SUITE 850, WASHINGTON, DC, 20036, US

(73) Assignee: MATSUSHITA ELECTRIC INDUSTRIAL CO., LTD., Osaka (JP)

(21) Appl. No.: 10/817,965

(22) Filed: Apr. 6, 2004

(51) Int. Cl. G06F 15/16

(52) U.S. Cl. 709/227; 709/217

(57) ABSTRACT

A method and a receiving apparatus for displaying at least one static media object delivered from a transmitting entity employing a delivery session according to the FLUTE (File Delivery over Unidirectional Transport) protocol is provided. Moreover, a computer-readable medium for storing instructions that, when executed by a processor cause the processor to display a static media object delivered from a transmitting entity to a receiving entity employing a delivery session according to the FLUTE protocol is provided. Moreover a transmitting apparatus for transmitting at least one static media object according to the FLUTE protocol is provided. A new method that allows temporally synchronizing and to update the delivered static media objects with other media objects is proposed. The proposed method may be especially suitable for the 3GPP MBMS Service as defined in 3GPP TS 22.246 specifications, but is not limited to thereto.

### BACKGROUND OF THE INVENTION

1. Field of the Invention

The present invention relates to a method and a receiving apparatus for displaying at least one static media object delivered from a transmitting entity employing a delivery session according to the FLUTE protocol. Further a transmitting apparatus for transmitting at least one static media object delivered from a transmitting entity employing a delivery session according to the FLUTE protocol is provided.

2. Description of the Related Art

The 3GPP (3^{rd} Generation Partnership Project) adopts IETF (Internet Engineering Task Force) standardized protocols like RTP, UDP, IP for the transport and packet-switch codecs like AMR (Adaptive Multi-Rate) and H.264 (MPEG 4 part 10) for encoding media. The 3GPP Packet Switched Streaming Services—3GPP PSS—(see 3GPP TS 26.234: “Universal Mobile Telecommunications System (UMTS); Transparent end-to-end streaming service; Protocols and codecs”, September 2003, available at http://www,3gpp.org) use the RTP/UDP protocol stack to stream audio/video/text media.

Along with streaming and file download, carousel services have been specified as one of three 3GPP MBMS user service classes (see 3GPP TS 22.246: “Multimedia Broadcast/Multicast Service (MBMS) user services; Stage 1 (Release 6)”, March 2004, available at http:/www.3gpp.org). Applications utilizing the carousel service are various, such as the following examples:
Live Ticker. This application provides textual data to the user repetitively and updated at certain times—periodically as well as on demand—to reflect changes.
Audio and video at low bit-rates. When the available bandwidth for a transport bearer is rather low to provide streaming video, still images might be delivered with the carousel services instead. The images are updated periodically or at certain times, when the content changes, and are synchronized with the corresponding audio stream.
General Content distribution. The protocol used for the carousel service is in particular suitable to transport binary data in a transparent way. I.e., the protocol is not aware of the format of the transported data, whether it is audio/video/text or of any other application data. The method described herein keeps this features and adds the synchronization of the data with the static media.

A carousel service combines aspects from both file download and streaming services. However, the target media of this service may be only static media (e.g. text and/or still images). Time synchronization with other media may also be required. For example, text objects are delivered and updated from time to time.

Still images may also be collated to display low frame rate video. In common with the download service this service may also include reliability. Like file download, one intention of a carousel service is to reliably deliver static media objects to the user, for example text and still images,

However, in contrast to file download, timeliness of the data may be important for the synchronization of the static media itself (e.g. play-out, update) and with other data objects. Hence, typically 100% reliability may not be always necessary. The content represented by a media object may change during a session. Consequently, delivered media objects may need to be updated, not necessarily periodically but also on demand. Thus, it may be desirable that the carousel service provides means for media update and synchronization with other media objects within a multimedia session.

Real-Time Transmission Protocol

The Real-time Transmission Protocol (RTP) provides end-to-end delivery services for data with real-time characteristics including payload type identification, sequence numbering, and time stamping. RTP is primarily designed (but not limited) to satisfy the needs of multi-participant multimedia conferences. Consequently, it supports multicast distribution.

While RTP is not limited to a specific data format, it is aware of the format of the data it transports. Thus, the specification and use of specific payload formats for each media format is required, e.g., such as for MPEG-1/MPEG2 audio and video, or 3GPP timed text as proposed in the Internet Draft by Rey et al., “RTP Payload Format for 3GPP Timed Text”, IETF AVT Working Group, February 2064 (available at http://www.ietf.org). This document introduces an overhead in the payload and complexity in the server and clients.

Another limitation of RTP is the lack of any means for reliability: RTP is designed to deliver the media in a timely manner, without any provision of error resilience. On the other side static media objects such as text and still images do require a certain degree of reliability of the transport service. Hence, appropriate techniques such as forward error correction (FEC) would have to be provided by the application. Basic means for such protection in RTP have been proposed in Rosenberg, “An RTP payload format for Generic Forward Error Correction”, RFC 2733, December 1999 (available at http://www.ieff.org). A more advanced method to protect the streams using Reed-Solomon packet-level encoding has been presented in the Internet Draft of Liebl et al., “RTP Payload Format for Erasure Resilient Transmission of Progressive Multimedia Streams”, Work in Progress, October 2003 (available at http://www.ietf.org). However, both of these approaches still demand for specific payload formats for each media, thus suffering the aforementioned shortcomings.

Reliable Multicast Protocols

Generally, there are many ways to provide reliable multicast transport services, as surveyed in Handley et al., “The Reliable Multicast Design Space for Bulk Data Transfer”, RFC 2887, August 2000 (available at http://www.ietf.org). The IETF RMT Working Group has recently proposed the FLUTE protocol as specified in Internet Draft of Paila et al., “FLUTE—File Delivery over Unidirectional Transport”, December 2003 (available at http://www.ieff.org) which is incorporated herein by reference. The FLUTE protocol has been proposed for unidirectional delivery of binary objects (files), such as text and images.

ARIB B24 Standard

The Japanese ARIB Standard is a series of documents that specify the transmission system (air interface), the audio/video and multiplexing, the data coding and transmission, the service information and the conditional access for digital broadcasting systems. It also gives some guidelines on the receiver structure and operational guidelines for terrestrial television broadcasting.

The ARIB standard employs the MPEG2 Standard for encoding and multiplexing of the audio and video data. It is also there specified that the MPEG2 multiplexing technique shall be used to transmit the data in packet networks.

Nevertheless, the ARIB specification lacks several features that this invention fulfils:
ARIB does not specify any packet level resilience method, e.g. some sort of application level forward error correction such as forward error correction (FEC) or unequal erasure protection (UXP) schemes. A resilience mechanism is rather provided at the lower layers (physical layers, air interface).
ARIB requires the audio/video coding to comply the MPEG2 standard, making a transcoding from a given codec, say AMR, to MPEG2 mandatory.
ARIB is not accepted in the 3GPP for Multicast/Broadcast Multimedia Services (MBMS).

The above shortcomings may invalidate the ARIB standard (and any of its parts) as a candidate for the transmission of multicast multimedia data in 3GPP.

FLUTE has several properties which make it well suited for the target applications:
Usage of forward error correction (FEC), an open-loop scheme for providing reliability.
Definition of a file delivery session including transport details.
In-band signaling of the transport parameters of the session.
In-band signaling of the properties of delivered files.
In-band signaling of details associated with the multiplexing of multiple files within a session.

However, timing information for synchronization purposes is not defined within the FLUTE specification. A possible solution is the usage of SMIL (see “Synchronized Multimedia Integration Language (SMIL 2.0)”, W3C Recommendation, August 2001, available from http://www.w3.org/TR/smil20) on the application level to synchronize the transported objects. However, SMIL does not support the update of media objects during a session. Instead, the media objects used in a SMIL presentation must be known in advance at presentation start and cannot change dynamically.

Currently, FLUTE is discussed within 3GPP as the most promising protocol for reliable multicast services. The following paragraphs will explain some of the important concepts of FLUTE, which may be necessary for the understanding of the present invention:
A file delivery session comprises all the objects transmitted with a single FLUTE instance.
The File Delivery Table (FDT) provides a means to describe various attributes associated with media objects (files) that are delivered within a file delivery session. The attributes relate to the delivery of the files and the file themselves. Examples of such attributes are (not mutually exclusive nor exhaustive); the Transport Object Identifier value representing a file within the FLUTE session; the ID of the instantiated FEC building block; the globally unique identifier of the file, expressed as either absolute or relative URI the MIME media type, size, encoding of the file; etc.
Each media object within a file delivery session is identified by the Transport Object Identifier (TOI). The purpose of the TOI is to provide means for demultiplexing of packets which belong to different media objects being transported within the same FLUTE session.

FLUTE generally fits very well as a transport protocol to reliably push media objects to the end devices over a unidirectional multicast channel. But FLUTE currently just provides general means for the transport of media objects, the methods for providing application semantics are still open issues, which have to be addressed. In particular, solutions to the following problems have not been proposed.

One important issue to provide is the mapping of media objects. The application semantics of a delivery session according to the FLUTE protocol are transparent to the transport level, i.e. the transport level is only aware of the transported media objects.

The application semantics may include the application-specific scene description, that is, the definition of different display regions and audio channels, as well as their arrangement within the application. E.g., in a multimedia presentation, a rectangular region A (position [xA,yA], width wA, height hA, display layer IA) might be defined for the display of video frames or images, while an overlapping (higher display layer) rectangular region B (position [xB, yB), width wB, height hB, display layer lB) might be defined for the display of the synchronized caption. Furthermore, a rectangular region C (position [xC, yC], width wC, height hC, display layer lC) might be assigned to advertisement, as depicted in FIG. 1. In order to display the downloaded media objects in the appropriate application object, a means is needed for easy and efficient mapping.

Another problem not yet solved is synchronization. Media objects may need to be synchronized on the application level, which demands for timing information for each of the correspondent objects.

Further the temporal relations between objects may need to be resolved, in particular when one media object updates and replaces another one. This also brings up a related problem namely the referencing downloaded objects. The downloaded media objects may need to be referenced in the local cache of the terminal, in order for the client application to be able to load them into the display at the appropriate time.

### SUMMARY OF THE INVENTION

Therefore improved techniques for delivering and displaying static media objects are provided that may overcome at least one of the above outlined problems.

According to one embodiment of the present invention a method for displaying at least one static media object delivered from a transmitting entity to a receiving entity employing a delivery session according to the FLUTE protocol is provided. According to the method a static media object and its timing information may be received from the transmitting entity at the receiving entity, wherein the timing information is provided to the receiving entity within a file element of a file delivery table instance of the delivery session. Further, the received static media object may be displayed in a display area for a display period defined by the received timing information.

Another embodiment of the present invention relates to a receiving apparatus for displaying at least one static media object delivered from a transmitting entity employing a delivery session according to the FLUTE protocol. The receiving entity may for example comprise a receiver for receiving a static media object and its timing information from the transmitting entity at the receiving entity, wherein the timing information is provided to the receiving entity within a file element of a file delivery table instance of the delivery session. The receiving entity may further comprise a display for displaying the received static media object in a display area for a display period defined by the received timing information.

A further embodiment of the present invention provides a transmitting apparatus for transmitting at least one static media object delivered to a receiving entity employing a delivery session according to the FLUTE protocol. The transmitting entity may comprise a transmitter unit for transmitting a static media object and its timing information to the receiving entity, wherein the timing information is provided to the receiving entity within a file element of a file delivery table instance of the delivery session.

Even another embodiment of the present invention is related to a computer-readable medium for storing instructions that, when executed by a processor, cause the processor to display a static media object delivered from a transmitting entity to a receiving entity employing a delivery session according to the FLUTE protocol by receiving a static media object and its timing information from the transmitting entity at the receiving entity, and displaying the received static media object in a display area for a display period defined by the received timing information. The timing information may for example be provided to the receiving entity within a file element of a file delivery table instance of the delivery session.

In a further embodiment of the present invention provides a computer-readable medium for storing instructions that, when executed by a processor, cause the processor to initiate the transmission of a static media object delivered from a transmitting entity to a receiving entity employing a delivery session according to the FLUTE protocol by providing a static media object and its timing information to the receiving entity, wherein the timing information is provided to the receiving entity within a file element of a file delivery table instance of the delivery session.

### BRIEF DESCRIPTION OF THE DRAWINGS

The accompanying drawings are incorporated into and form a part of the specification to illustrate several embodiments of the present invention. These drawings together with the description serve to explain the principles of the invention. The drawings are only for the purpose of illustrating examples of how the invention can be made and used and are not to be construed as limiting the invention to only the illustrated and described exemplary embodiments. Further, features and advantages will become apparent from the following and more particular description of the various embodiments of the present invention, as illustrated by the accompanying drawings wherein:

FIG. 1 shows an exemplary arrangement of display objects,

FIG. 2 shows an exemplary streaming environment according to an embodiment of the present invention, FIG. 3 shows an exemplary flow chart of the operation of a streaming environment employing the FLUTE protocol according to an embodiment of the present invention,

FIG. 4 shows an exemplary receiving apparatus according to an embodiment of the present invention and

FIG. 5 shows an exemplary transmitting apparatus according to an embodiment of the present invention.

### DETAILED DESCRIPTION OF THE INVENTION

Similar or corresponding details in the figures are marked with the same reference numerals.

Data of streaming applications may be generally grouped into two classes. One class may be referred to as continuous media, such as an audio and/or video stream provided from a streaming server to a receiving entity. These data are provided continuously to the receiver and have certain timing constraints with respect to their timely delivery to the user.

The second class may be referred to as static media, which are not provided in a continuous flow to the receiver and may likewise have timing constraints with respect to their provision to the user. One representative of this class may be some piece of data delivered by a carousel transport mechanism.

A static media object may have timing constrains with respect to its timely presentation to the user and may thus be synchronized to continuous flow data (i.e. having timing requirements). E.g. an image that may be displayed at a given instant synchronized with an audio stream in a multimedia presentation does not have a continuous flow such as for example audio or video, but it may certainly have timing constraints.

Consequently, the term “static media object” used frequently in the present application may denote pieces of information that have timing requirements: e.g. a certain play-out time, expiration time, and schedule associated with them, but in contrast to audio and video lack of a continuous flow.

It should be further noted that though the focus in this document is on the delivery and provision of visual objects the present application for example to different audio channels may be accomplished in a similar manner as described in the next sections. In this context, it is often referred to display regions as display objects in this document. However, the application to different audio channels is straight forward.

One embodiment of the present invention establishes the synchronization of static media objects on the application level by exploiting the extensibility of the File Delivery Table and by defining additional file attributes in order to carry application-specific timing information for the transported media objects.

Another embodiment of the present invention is to provide an integrated and light-weighted solution to at least one of the aforementioned problems. According to one embodiment of the present invention the Transport Object Field-already defined in the FLUTE protocol header may be employed to solve problem to map static media objects and display objects. In the prior-art the TOI field has been commonly intended for demultiplexing purposes on the transport level, i.e. for demultiplexing different media objects transported within the same FLUTE session.

According to a further embodiment of the present invention by combining the two aspects mentioned above, the TOI and the timing information may be used in order to resolve the relation of one media object updating another one without the introduction of any additional and explicit protocol field or payload extension.

Moreover another embodiment of the present invention solves the problem of referencing the downloaded objects in the cache by providing a local URL as a value in the “Content-Location” attribute of the FLUTE File Delivery Table for the corresponding media object.

Before or at the beginning of a session, the transmitting entity, for example a streaming server, may provide the receiving entities, for example mobile terminals receiving the session, with the application semantics comprising for example a session and scene description.

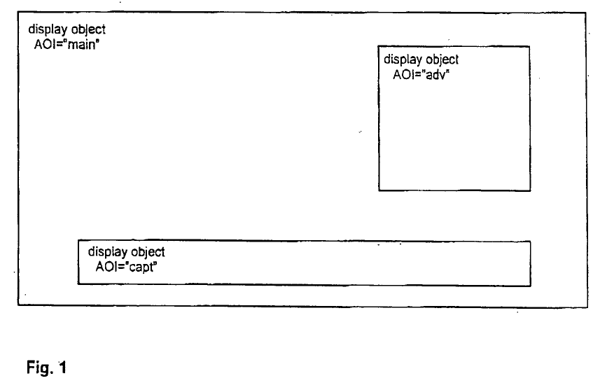

According to one embodiment of the present invention, the semantics may for example include the arrangement of the display objects defined by the application and mapping of these objects to the media objects in the corresponding FLUTE session. For this purpose display areas may be defined similar to SMIL or MPEG-4 and each of these display objects may be referenced by a unique identifier, which will be referred to as the Application Object Identifier (AOI) in this document. An example of the arrangement of the three display objects for a multimedia session is depicted in FIG. 1 and an exemplary definition of display objects in a XML-like syntax may be:

| | |
|---|---|
| <layout> | |
| <aoi=”main” | xpos=”0” ypos=”0” width =”100%” height=”100%” |
| | layer=”0” /> |
| <aoi=”capt” | xpos=”10%” ypos=”10%” width=”80%” height=”15%” |
| | layer=”1” /> |
| <aoi=”adv” | xpos=”60%” ypos=”40%” width=”35%” height=”50%” |
| | layer=”1” /> |
| </layout> | |

It is noted that the syntax above is merely an exemplary representation of an XML-like syntax for describing the arrangement of display objects and is not intended to limit the present invention thereto.

The mapping may be described by associating each display object referenced by its associated AOI—with a corresponding Transport Object Identifier (TOI) assigned within a FLUTE instance to a media object, which is supposed to be displayed in that particular display area. The exemplary mapping is presented in the table below:

| AOI | TOI |
|---|---|
| main | 2 |
| adv | 4 |
| capt | 5 |

The transmission of the mapping information to the clients, for example in form of a table, is not limited to a single method or protocol. For example protocols as HTTP GET or SAP may be used for transmitting the mapping information.

However, when utilizing FLUTE for this purpose several advantages may result therefrom: additional overhead that may be introduced by a mix of protocols can be avoided, and dynamic updates of the mapping table thus allowing an update of static media objects may be supported as will be outlined in further detail below.

According to an embodiment of the present invention the mapping information may be transported as a transport object within the corresponding FLUTE session. This transport object may for example be the first transport object following the initial File Delivery Table (FDT). The terms “file” may be used as a pseudonym for “object” within the context of FLUTE.

Since the format of the mapping should allow simple and fast parsing, for example a “text/tab-separated-values” MIME type may be employed to store the information in a conforming text file. Of course, any other suitable MIME type may be used to encode the mapping information to the receiver.

Alternatively, in another embodiment of the present invention a predefined static mapping of AOIs to TOIs may be used which permanently maps each AOI to a specific TOI. It may be also possible that initially a static mapping exists which may be subsequently updated by mapping information provided to the receiving entity.

The mapping information—for example stored in form of a file—may be encapsulated in the payload of the FLUTE session like any other transport object, and it is identified by a unique Transport Object Identifier. For example, the TOI value of 1 may be reserved for delivering mapping information.

As shown in the exemplary XML scheme according to a further embodiment of the present invention below below, a file entry <File> of an FDT instance <FDT-Instance> may be used to identify the location of mapping information, which map TOIs and AOIs:

<?xml version=“1.0” encoding=“UTF-8”?>

| | |
|---|---|
| <FDT-Instance | xmlns:xsi=“http://www.w3.org/2001/XMLSchema- |
| | instance” |
| | xmlns:fl=“http://www.example.com/flute” |
| | xsi:schemaLocation=“http://www.example.com/flute- |
| | fdt.xsd” |
| | Expires=“2890842807”> |

| | |
|---|---|
| <File | Content-location= |
| | “www.example.com/serviceID/sessionID/mapping.txt” |
| | TOI=“1” Content-Type=“text/tab-separated-values”/> |
| <File ... | |

</FDT-Instance>

The FDT may provide a means to describe various attributes associated with files that are to be delivered within the file delivery session. The following exemplary attributes, which are not intended to be mutually exclusive nor exhaustive, may be provided. Attributes related to the delivery of file may be the TOI value that represents the file FEC Instance ID, the FEC Object Transmission Information, a size of the transport object carrying the file, and an aggregate rate of sending packets to all channels. Possible attributes related to the file itself may be its name, identification and location for example specified by an URI, the MIME media type of the file, the size of file, its encoding and a message digest of file. The FDT may comprise a subset of these attributes for each file, but may always contain at least the TOI of the file and its content location.

Logically, the FDT may be described as a set of file description entries for files to be delivered in the session. Each file description entry may include the TOI for the file that it describes and the URI indicating the location of the file. The TOI may also be included in each data packet structured in accordance with the FLUTE specification during the delivery of the file. This format may be an ALC/LCT format as for example specified in Luby et al, “Asynchronous Layered Coding (ALC) Protocol Instantiation”, RFC 3450, December 2002 and Luby et al., “Layered Coding Transport (LCT) Building Block”, RFC 3451, December 2002 (both available at http;//www.ietf.org).

Therefore the TOI carried in the file description entry may facilitate the determination which data packets contain information about which file. Each file description entry may also contain one or more descriptors that map the above-mentioned attributes to the file at the receiver.

Each file delivery session may use an FDT that is local to the given session. The FDT may provide a file description entry mapped to a TOI for each file appearing within the session. Within the delivery session according to the FLUTE protocol the FDT may be delivered as so called FDT Instances as shown in the exemplary XML scheme above.

An FDT Instance may contain one or more file description entries of the FDT. Any FDT Instance may be equal to, a subset of, a superset of, or complement to any other FDT Instance. A certain FDT Instance may be repeated several times during a session, even after subsequent FDT Instances (with higher FDT Instance ID numbers) have been transmitted. Each FDT Instance may contain at least a single file description entry and at most the complete FDT of the file delivery session.

A receiving entity of the file delivery session may keep an FDT database for received file description entries. The receiving entity may maintain the database, for example, upon reception of FDT Instances. Thus, at any given time the contents of the FDT database may represent the receivers current view of the FDT of the file delivery session.

Since FDT database is an abstract concept, the structure and the maintaining of the FDT database may be implemented in many different ways. Hence the examples given in this document merely serve for-exemplary purposes for explaining the concepts and ideas underlying the present invention.

As has become apparent from the above, one of the various aspects of the present invention addresses the mapping of transmitted media objects (TOI) to application-specific display objects (AOI), as described previously.

While the association of TOIs to corresponding AOIs may for example be determined in advance, the assignment of a TOI to a particular media object may be done at transport time, i.e., dynamically. When the application needs a media object to be displayed in a particular display object, the sender may assign the corresponding FLUTE TOI to this media object using the session's mapping information. Thereby, the original purpose of the TOI field—to provide means for demultiplexing of different media objects transported within a single FLUTE instance—may be preserved.

This approach may have the additional advantage that it supports an implicit and light-weighted update mechanism, as will be described below. However, it may demand that the assignment of TOIs is not transparent to the application, i.e., the interface of the FLUTE protocol implementation may need to allow the specification of the TOI to be used for a particular object. This, however, does not violate the FLUTE specifications, since the latter does not regulate how TOIs are assigned.

With the provided mapping using FLUTE's TOI field and application-specific AOI or with a predefined static mapping of TOIs and A01s the client-side application may know where to display each media object transported within the associated FLUTE session.

For example a static mapping may be-implemented by assigning the TOI value of 2 to the AOI value of 1, the TOI value of 3 to the AOI value of 2, etc. Another alternative may be to store the display objects in a list, array, or the like, wherein the first element may be mapped to a TOI of value 2, the second element in the list to a TOI of value 3, etc. These examples are only intended to illustrate how a static mapping may be implemented and do not limit static mapping to those implementations.

However, to support a timely display and synchronization of media objects, two additional file attributes for the File Delivery Table of FLUTE may be defined according to a further embodiment of the present invention. These extensions conform to the requirements of the FLUTE specifications, and may be defined as follows:

<?xml version=“1.0” encoding=“UTF-8”?/>

| | |
|---|---|
| <xs:schema | xmlns:xs=http://www.w3.org/2001/XMLSchema |
| | xmlns:fl=http://www.example.com/flute |
| | elementFormDefault:xs=“qualified” |
| | targetNamespace:xs=“http://www.example.com/flute”> |

```
    <xs:element name=“FDT-Payload”>
        <xs:complexType>
            <xs:attribute name=“Expires” type=“xs:string”
            use=“required”/>
            <xs:attribute name=“Complete” type=“xs:boolean”
            use=“optional”/>
            <xs:sequence>
                <xs:element name=“File” maxOccurs=“unbounded”>
                    <xs:complexType>
                        ...
```

| | |
|---|---|
| <xs:attribute | name=“Content-Begin” |
| | type=“xs:unsignedLong” |
| | use=“optional” /> |
| <xs:attribute | name=“Content-Duration” |
| | type=“xs:unsignedLong” |
| | use=“optional” /> |

```
                        ...
                    </xs:complexType>
                </xs:element>
            </xs:sequence>
        </xs:complexType>
    </xs:element>
</xs:schema>
```

The attributes “Content-Begin” and “Content-Duration” may indicate the application time at which the corresponding media object should be displayed, and the duration after which it is regarded invalid and should be removed, respectively. Both file attributes may be generic and fit to different media types. Furthermore, since both are optional attributes, they may only be applied to time-lined static media. Thus, no compatibility problems or additional overhead is introduced.

According to a further embodiment of the present invention both previously described concepts, i.e. the use of mapping information and the use of timing information, may be employed in combination to provide object update functionality, without the need of any additional and explicit update information.

In case a media objects should be updated or exchanged, the client may receive the new media object assigned a particular TOI while the preceding media object with the same TOI may still be valid and displayed out of the client's display buffer.

Once the last packet delivering the new object has been received and stored in the local cache, the displaying application may be informed about the assignment of a new object to the TOI and the begin time of this object. An application process may resolve the mapping to the corresponding display object (AOI) according to the TOI. It may also schedule a refresh display event for the corresponding display area according to the value of the “Content-Begin” attribute. If the time specified in this attribute is already exceeded, the display refresh may be triggered immediately.

The update of a media object does not necessarily have to be predetermined; but it may be generated on-the-fly, which makes it well suited for live sessions. In this exemplary case, a “Content-Duration” attribute of the preceding object may not be necessary and may usually not be provided, since the duration time may not be known in advance. Hence, objects may be valid until an update arrives.

If by some reasons a “Content-Duration” attribute is provided, and its value determines that the play-out of the media object exceeds the “Content-Begin” value of the subsequent media object, the former may be interrupted by the described refresh event.

As indicated above, media objects may for example be stored in a local cache at the receiving entity. For referencing downloaded media objects from the cache, the “Content-Location” attribute defined in the FLUTE specification may be utilized. This field may indicate the file's location using a URI (Uniform Resource Identifier):

Some applications may require one or more subsequent update media objects, i.e. a carousel delivery of the objects to be cached at the clients at the same time while the first media object is still valid. In order to resolve the ambiguity if all of the above objects are assigned the same TOI, the application may maintain a database of downloaded media objects in the local cache. The database may for example contain fields for the TOI, display time interval and content location.

Another solution may be that each media object is assigned a unique TOI. The mapping between TOIs and AOIs may then be provided by for example extending the FDT by an additional optional parameter containing the mapping information for the application that is the Application Object Identifier (AOI) or mapping one display area (i.e., its AOI) to a list of subsequent TOIs, i.e., [TOIₘᵢₙ, TOIₘₐₓ].

This may allow concurrently storing a number of (TOIₘᵢₙ−TOIₘₐₓ) media objects at the client side referencing the same display area. The “Content-Begin” field may for example be used for determining the right display order.

FLUTE does not define how TOIs are assigned to individual transport objects. Thus, implementations of FLUTE may handle it in different ways. One way may be to define the API (application programming interface) such that the application can control the assignment of TOI values to media objects.

Another way may be to implement FLUTE such that the TOI value is incremented for each object. In this case, the TOI assignment is not controlled by the application.

A further means to tell the receiving entity which AOI is used in conjunction with which TOI may be an additional and optional attribute to the File Delivery Table denoting the associated AOI for the purpose of mapping;
<xs:attribute name=“AOI” type=“xs:positiveInteger” use=“optional”/>

In order to avoid ambiguity if both a mapping table and the “AOI” attribute have been provided, the one of the values, for example the “AOI” field in the FDT, may have the higher priority.

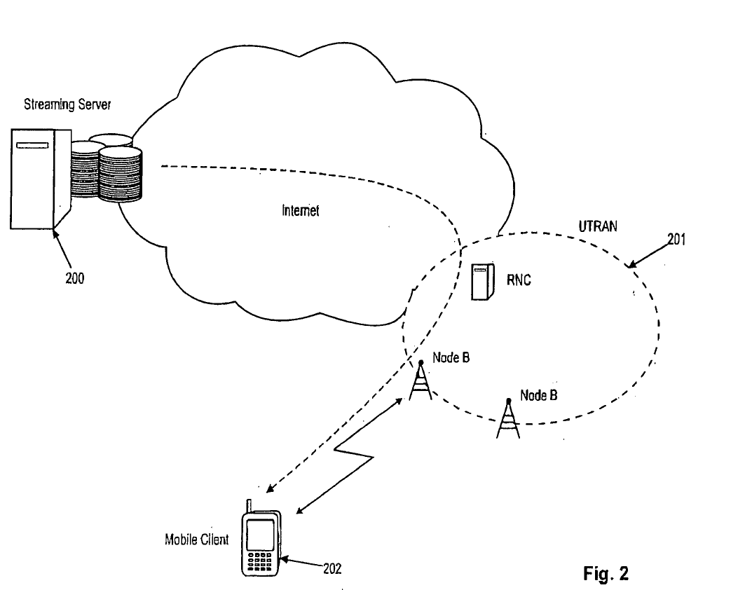

Next an exemplary embodiment of a streaming environment streaming environment according is briefly described with reference to FIG. 2. A transmitting apparatus, for example a streaming server 200 provides data packets of a FLUTE delivery session to a receiving apparatus 400, such as the mobile terminal 202. The data comprising inter alia the static media objects belonging to the session may for example be provided via the Internet or any other packet switched network and via a mobile communication network, such as an UMTS Terrestrial Access Network (UTRAN 201) to the mobile terminal.

FIG. 3 shows an exemplary flow chart of the operation of a streaming environment employing the FLUTE protocol according to an embodiment of the present invention. It should be noted that according to another embodiment only a subset of the steps illustrated in FIG. 3 may be executed by the receiving apparatus and/or transmitting apparatus, respectively. The flow chart shown in FIG. 3 is merely intended to describe one embodiment of the present invention and is not intended to limit the invention thereto,

In block 301 the transmitting apparatus may (dynamically) determine the associations between the different display objects (i.e. display areas) and the media objects to be delivered within the delivery session and to be displayed at the receiving apparatus.

In block 302 the transmitting apparatus may generate application semantics for the delivery session, wherein the association data may either be directly included in the semantics or may be referenced by same as outlined above. The application semantics may be next transmitted to the receiving apparatus in block 303. For example the mapping information may be transmitted in <File> element of a FDT instance as outlined previously. In a further embodiment, additional fields in the <File> element may be defined comprising the mapping information.

The receiving apparatus may receive the application semantics in step 311 and may extract the application objects and, in case of being signaled in-band, the association data. In case the association data is signaled out-band, the receiving apparatus may obtain the association data in step 313, for example from the transmitting apparatus or

any other apparatus referenced by the application semantics.

Having obtained the information the receiving apparatus may initialize session parameter comprising inter alia a mapping of AOIs of the display objects to at least one TOI, as explained in greater detail above.

The transmitting apparatus may further generate timing information for a media object to be transmitted to the receiving apparatus in step 304. These timing information may be added to a generated FDT instance, e.g. into a <File> element thereof, in step 305. The block 304 further indicates that location information where the media object may be received from may be further comprised to the FDT instance, Commonly the media objects of a FLUTE session may be provided from the transmitting apparatus. However, their location where the transmitting apparatus has obtained the media objects from may be indicated using for example a “Content-Location”, attribute of a <File> element, Alternatively, it may also be possible that the receiving apparatus uses the location information in the “Content-Location” attribute to obtain the respective object from the indicated location.

Upon having formed the FDT instance, same may be transmitted to the receiving apparatus in step 306. The-FDT instance may be received by the receiving apparatus in step 314 and the media object may be retrieved in step 315 from the transmitting apparatus, which ha transmitted the media object in step 307.

As outlined above, in an alternative embodiment, the location information provided to the receiving apparatus may be used by same to request and receive the media object from the indicated location. This alternative embodiment may be for example applicable in cases the service/content provider allows alternatively for pull (unicast) download of media objects of the session. E.g., if lots of connection interrupts occur, a receiver might switch from the cheaper push service (multicast) to a more expensive pull service (unicast).

Further, the timing information may be extracted from the FDT instance in step 316 in order to allow displaying the media object for a time period indicated by the timing information.

Further, based on an object identifier, e.g. TOI, also comprised in the FDT instance, the display object in which the media object should be displayed may be determined based on the association data in step 317. Moreover evaluating the timing information and the association data the obtained media object may be displayed in the correct display area with the correct timing.

The skilled person will appreciate that many modifications of the method proposed by the embodiment of the present invention shown in FIG. 3 may be made without departing from the scope of the present invention.

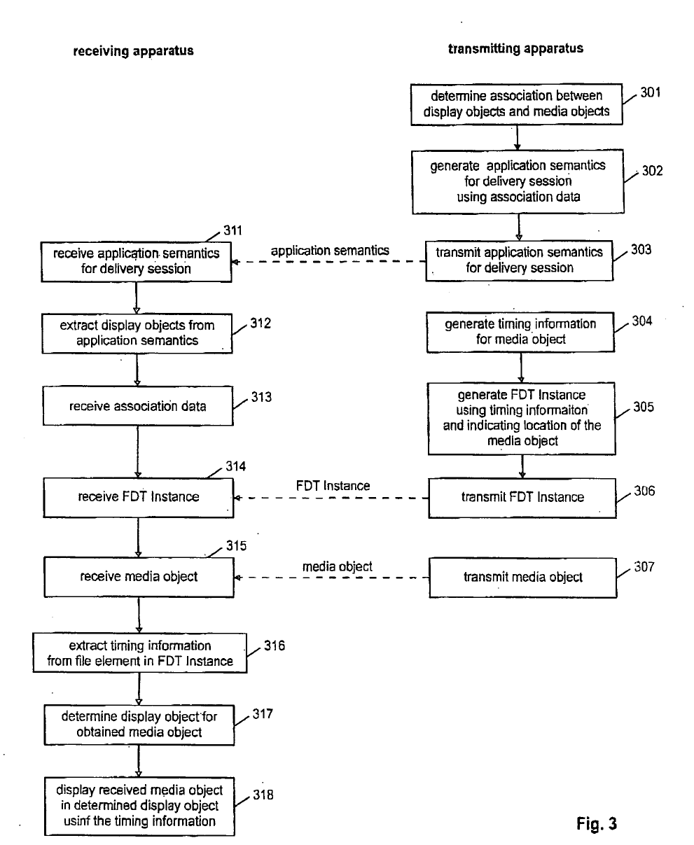

FIG. 4 shows an exemplary receiving apparatus 400 according to an embodiment of the present invention. The receiving apparatus 400 may comprise a receiver 401 for receiving information from many sources. Inter alia the receiver 401 may be used to obtain static media objects of a FLUTE session and/or to receive data related to the session.

Moreover the receiving apparatus may further comprise a processor 402, which may inter alia be used to process the information received by the receiver 401. For example, the processor may be used to process the timing information, to dissolve the associations between media objects and display objects, to update the associations thereof, etc. The various instructions executed by the processor 403 to perform the various tasks may be stored in a memory 404. The memory 404 may also be used as a cache for the session data, as for example the association data, the media objects delivered in the FLUTE session, etc. Moreover, the receiving apparatus 400 may comprise display 402 for displaying the media objects received to a user.

Those of ordinary skill will appreciate that for brevity only some exemplary tasks and functions of the different components.,of a receiving apparatus 400 have been outlined and recognize that these components may fulfill a variety of tasks and functions not explicitly mentioned herein but within the scope of the present invention. Moreover they will recognize that the receiving apparatus 400 may comprise many more components not shown in FIG. 4.

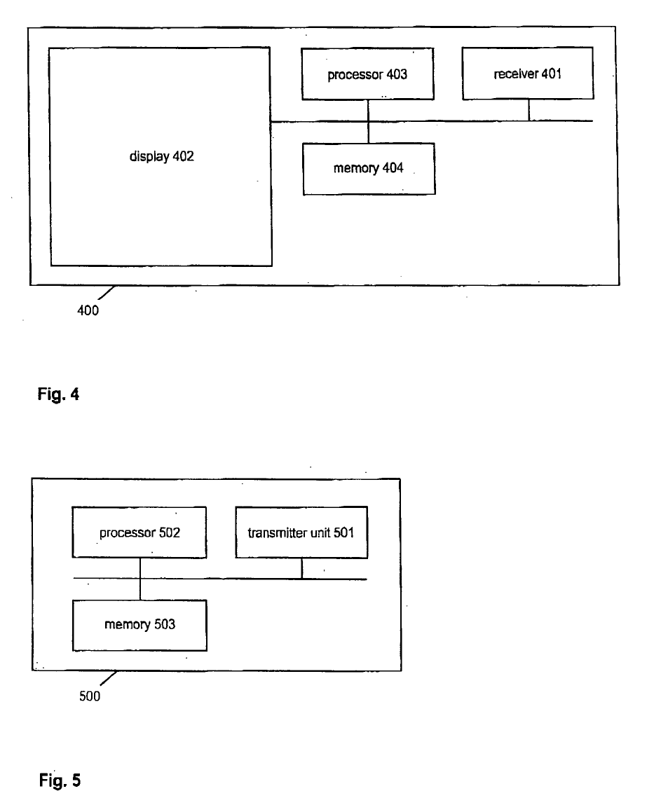

Turning now to FIG. 5 shows an exemplary transmitting apparatus 500 according to an embodiment of the present invention is shown. The transmitting apparatus 500 may comprise a transmitter 501, The transmitter 501 may transmit for example the data related to a FLUTE session, such as applications semantics or media objects.

Moreover the transmitting apparatus 500 may further comprise a processor 502 for processing the data related to the FLUTE session and to determine session parameters prior to transmission. The respective instructions to be executed by the processor 502 to fulfill its various tasks may be stored in a memory 503 of the transmitting apparatus 500.

Again, those of ordinary skill will appreciate that for brevity only some exemplary tasks and functions of the different components of a transmitting apparatus 500 have been outlined. Those skilled in the art recognize that the components may fulfill a variety of tasks and functions not explicitly mentioned herein but within the scope of the present invention. Moreover they will recognize that the transmitting apparatus 500 may comprise many more components not shown in FIG. 5.

Another embodiment of the present invention relates to the implementation of the above described various embodiments and variations thereof using hardware and software. It is recognized that the various above mentioned methods and proposed solutions as well as the various logical blocks, modules, circuits described above may be implemented or performed using computing devices, as for example general purpose processors, digital signal processors (DSP), application specific integrated circuits (ASIC), field programmable gate arrays (FPGA) or other programmable logic devices, etc. <The various embodiments of the present invention may also be performed or embodied by a combination of these devices.

Further, the various embodiments of the present invention may also be implemented by means of software modules which are executed by a processor or directly in hardware. Also a combination of software modules and a hardware implementation may be possible. The software modules may be stored on any kind of computer readable storage media, for example RAM, EPROM, EEPROM, flash memory, registers, hard disks, CD-ROM, DVD, etc.

While the invention has been described with respect to various exemplary embodiments, it will be apparent to those skilled in the art that various modifications, variations and improvements of the present invention may be made in the light of the above teachings and within the purview of the appended claims without departing from the spirit and intended scope of the present invention.

For instance, in a variation of an embodiment the receiving entity application may further receive application semantics describing the delivery session and at least one display area for displaying a static media object. The semantics may provide an association of each display area to a display area identifier. Moreover, an object identifier of each static media object to be delivered in the delivery session may be associated to a display area identifier, wherein the display area is identified by the association of the static media object's identifier to a display area identifier.

For example a static media object may be dynamically associated to an object identifier at the transmitting entity.

According to a further variation the association of the static media object to a display area may be obtained from data in an association file comprised in a file delivery table instance of the delivery session.

For example, the data in the association file may be provided in a format using a character, which is not used for coding the data, as a separator.

In a further variation the association of the static media object to a display area may be based on information comprised in a file delivery table instance of the delivery session.

Moreover, according to a further variation of an embodiment, the computer readable medium may further store instructions that, when executed by the processor, cause the provision of location information of the static media object and of the static media object's identifier to the receiving entity within a file element of a file delivery table instance of the delivery session.

Further, each received static media object, its object identifier, its associated display area identifier and its display period may be stored in a cache at the receiving entity.

According to a further variation the method may determine which of a plurality of static media objects associated to one display area is displayed in the display area based on the display period of each of the plurality of static media objects.

The display period may indicate the point in time at which displaying the static media object is started and a display duration for the static media object or the point in time at which displaying the static media object is stopped.

In another variation a plurality of object identifiers may be associated to one display area is identifier.

In another variation, a receiving apparatus may further comprise a processor associating an object identifier of each static media object to be delivered in the delivery session to a display area identifier. The receiver may be adapted to receive application semantics describing the delivery session and at least one display area for displaying a static media object. As mentioned above, the semantics may provide an association of each display area to a display area identifier. Moreover, the display area may be identified by the association of the static media object's identifier to a display area identifier.

In a further variation the processor may be adapted to dynamically associate the static media object to an object identifier.

According to another variation the processor may be adapted to obtain data from an association file comprised in a file delivery table instance of the delivery session to associate the static media object to a display area.

The data in the association file may for example be provided in a format using a character, which is not used for coding the data, as a separator.

In a further variation the processor may be adapted to associate the static media object to a display area based on information comprised in a file delivery table instance of the delivery session.

Moreover, according to a further exemplary variation of the receiving apparatus, the processor may be adapted to extract a location of the static media object and the static media object's identifier from a file element of a file delivery table instance of the delivery session.

The receiving apparatus may for example also comprise a memory for storing each received static media object, its object identifier, its associated display area identifier and its display period in a cache at the receiving apparatus.

In another variation of the receiving apparatus the processor may be further adapted to determine which of a plurality of static media objects associated to one display area is displayed in the display area based on the display period of each of the plurality of static media objects.

As outlined above the display period may indicate the point in time at which displaying the static media object is started and a display duration for the static media object or the point in time at which displaying the static media object is stopped.

Moreover in a further variation a transmitting apparatus may further comprise a processor associating an object identifier of each static media object to be delivered to the receiving entity in the delivery session to a display area identifier. Moreover the transmitter may be adapted to transmit application semantics describing the delivery session and at least one display area for displaying a static media object, wherein the semantics provide an association of each display area to a display area identifier, and wherein the display area is identified by the association of the static media object's identifier to a display area identifier.

Moreover, the processor may for example be adapted to dynamically associate the static media object to an object identifier.

In another variation the processor may be adapted to provide data for associating the static media object to a display area in an association file comprised in a file delivery table instance of the delivery session and the transmitter may be adapted to transmit said data to the receiving entity.

In even another variation, a computer-readable medium may for further store instruction that, when executed by the processor, cause a reception of application semantics describing the delivery session and at least one display area for displaying a static media object, wherein the semantics provide an association of each display area to a display area identifier, and an association of an object identifier of each static media object to be delivered in the delivery session to a display area identifier. The display area may for example be identified by the association of the static media object's identifier to a display area identifier.

The computer-readable medium may optionally further store instruction that, when executed by the processor, cause a dynamic association of the static media object to an object identifier at the transmitting apparatus.

In another variation, the association of the static media object to a display area may be obtained from data in an association file comprised in a rile delivery table instance of the delivery session.

Another alternative variation may be that the association of the static media object to a display area is based on information comprised in a file delivery table instance of the delivery session.

Further it may be possible that a location of the state media object and the static media object's identifier are provided to the receiving entity within a file element of a file delivery table instance of the delivery session.

The computer-readable medium according to a further variation may further store instruction that, when executed by the processor, cause storing each received static media object, its object identifier, its associated display area identifier and its display period in a cache at the receiving entity.

In another optional variation to the computer-readable medium, same may further store instruction that, when executed by the processor, cause determining which of a plurality of static media objects associated to one display area is displayed in the display area based on the display period of each of the plurality of static media objects.

As outlined previously the display period may indicate the point in time at which displaying the static media object is started and a display duration for the static media object or the point in time at which displaying the static media object is stopped.

Further, a computer-readable medium may store instruction that, when executed by the processor, cause an association of an object identifier of each static media object to be delivered to the receiving entity in the delivery session to a display area identifier, and a transmission of application semantics describing the delivery session and at least one display area for displaying a static media object, wherein the semantics provide an association of each display area to a display area identifier, wherein the display area is identified by the association of the static media object's identifier to a display area identifier.

Moreover in a further variation, the computer-readable medium may store instruction that, when executed by the processor, cause a dynamic association of the static media object to an object identifier.

In addition, those areas in which it is believed that those of ordinary skill in the art are familiar have not been described herein in order to not unnecessarily obscure the invention described herein. Accordingly, it is to be understood that the invention is not to be limited by the specific exemplary embodiments, but by the appended claims.

1. A method for displaying at least one static media object delivered from a transmitting entity to a receiving entity employing a delivery session according to the flute (file delivery over unidirectional transport) protocol, the method comprising:
receiving a static media object and its timing information from the transmitting entity at the receiving entity, wherein the timing information is provided to the receiving entity within a file element of a file delivery table instance of the delivery session, and
displaying the received static media object in a display area for a display period defined by the received timing information.

2. The method according to claim 1, further comprising
receiving at the receiving entity application semantics describing the delivery session and at least one display area for displaying a static media object, wherein the semantics provide an association of each display area to a display area identifier,
associating an object identifier of each static media object to be delivered in the delivery session to a display area identifier,
wherein the display area is identified by the association of the static media object's identifier to a display area identifier.

3. The method according to claim 2, further comprising dynamically associating the static media object to an object identifier at the transmitting entity.

4. The method according to claim 2, wherein the association of the static media object to a display area is obtained from data in an association file comprised in a file delivery table instance of the delivery session.

5. The method according to claim 4, wherein the data in the association file is provided in a format using a character, which is not used for coding the data, as a separator.

6. The method according to claim 2, wherein the association of the static media object to a display area is based on information comprised in a file delivery table instance of the delivery session.

7. The method according to claim 6, wherein a location of the static media object and the static media object's identifier are provided to the receiving entity within a file element of a file delivery table instance of the delivery session.

8. The method according to claim 7, further comprising storing each received static media object, its object identifier, its associated display area identifier and its display period in a cache at the receiving entity.

9. The method according to claim 6, further comprising determining which of a plurality of static media objects associated to one display area is displayed in the display area based on the display period of each of the plurality of static media objects.

10. The method according to claim 7, wherein the display period indicates the point in time at which displaying the static media object is started and a display duration for the static media object or the point in time at which displaying the static media object is stopped.

11. The method according to claim 9, wherein in the step of associating an object identifier of each static media object to a display area identifier, a plurality 6f object identifiers is associated to one display area identifier.

12. A receiving apparatus for displaying at least one static media object delivered from a transmitting entity employing a delivery session according to the FLUTE (File Delivery over Unidirectional Transport) protocol, the receiving entity comprising:
a receiver for receiving a static media object and its timing information from the transmitting entity at the receiving entity, wherein the timing information is provided to the receiving entity within a file element of a file delivery table instance of the delivery session, and
a display for displaying the received static media object in a display area for a display period defined by the received timing information.

13. The receiving apparatus according to claim 12, further comprising a processor associating an object identifier of each static media object to be delivered in the delivery session to a display area identifier,
wherein the receiver is adapted to receive application semantics describing the delivery session and at least one display area for displaying a static media object, wherein the semantics provide an association of each display area to a display area identifier, and
wherein the display area is identified by the association of the static media object's identifier to a display area identifier.

14. The receiving apparatus according to claim 13, wherein the processor is further adapted to dynamically associate the static media object to an object identifier.

15. The receiving apparatus according to claim 13, wherein the processor is adapted to obtain data from an association file comprised in a file delivery table instance of the delivery session to associate the static media object to a display area.

16. The receiving apparatus according to claim 14, wherein the data in the association file is provided in a format using a character, which is not used for coding the data, as a separator.

17. The receiving apparatus according to claim 13, wherein the processor is adapted to associate the static media object to a display area based on information comprised in a file delivery table instance of the delivery session.

18. The receiving apparatus according to claim 17, wherein the processor is adapted to extract a location of the static media object and the static media object's identifier from a file element of a file delivery table instance of the delivery session.

19. The receiving apparatus according to claim 18, further comprising a memory for storing each received static media object, its object identifier, its associated display area identifier and its display period in a cache at the receiving apparatus.

20. The receiving apparatus according to claim 18, wherein the processor is further adapted to determine which of a plurality of static media objects associated to one display area is displayed in the display area based on the display period of each of the plurality of static media objects.

21. The receiving apparatus according to claim 17, wherein the display period indicates the point in time at which displaying the static media object is started and a display duration for the static media object or the point in time at which displaying the static media object is stopped.

22. A transmitting apparatus for transmitting at least one static media object delivered to a receiving entity employing a delivery session according to the FLUTE (File Delivery over Unidirectional Transport) protocol, the transmitting entity comprising:
a transmitter unit for transmitting a static media object and its timing information to the receiving entity, wherein the timing information is provided to the receiving entity within a file element of a file delivery table instance of the delivery session.

23. The transmitting apparatus according to claim 22, further comprising a processor associating an object identifier of each static media object to be delivered to the receiving entity in the delivery session to a display area identifier,
wherein the transmitter is adapted to transmit application semantics describing the delivery session and at least one display area for displaying a static media object, wherein the semantics provide an association of each display area to a display area identifier, and
wherein the display area is identified by the association of the static media object's identifier to a display area identifier.

24. The transmitting apparatus according to claim 23, wherein the processor is further adapted to dynamically associate the static media object to an object identifier.

25. The transmitting apparatus according to claim 23, wherein the processor is adapted to provide data for associating the static media object to a display area in an association file comprised in a file delivery table instance of the delivery session and
the transmitter is adapted to transmit said data to the receiving entity.

26. The transmitting apparatus according to claim 24, wherein the data in the association file is provided in a format using a character, which is not used for coding the data, as a separator.

27. The transmitting apparatus according to claim 22, wherein the display period indicates the point in time at which displaying the static media object is started and a display duration for the static media object or the point in time at which displaying the static media object is stopped.

28. A computer-readable medium for storing instructions that, when executed by a processor, cause the processor to display a static media object delivered from a transmitting entity to a receiving entity employing a delivery session according to the FLUTE (File Delivery over Unidirectional Transport) protocol by:
receiving a static media object and its timing information from the transmitting entity at the receiving entity, wherein the timing information is provided to the receiving entity within a file element of a file delivery table instance of the delivery session, and
displaying the received static media object in a display area for a display period defined by the received timing information.

29. The computer-readable medium according to claim 28, further storing instructions that, when executed by the processor, cause a reception of application semantics describing the delivery session and at least one display area for displaying a static media object, wherein the semantics provide an association of each display area to a display area identifier, and an association of an object identifier of each static media object to be delivered in the delivery session to a display area identifier,
wherein the display area is identified by the association of the static media object's identifier to a display area identifier.

30. The computer-readable medium according to claim 29, further storing instructions that, when executed by the processor, cause a dynamic association of the static media object to an object identifier at the transmitting entity.

31. The computer-readable medium according to claim 29, wherein the association of the static media object to a display area is obtained from data in an association file comprised in a file delivery table instance of the delivery session.

32. The computer-readable medium according to claim 29, wherein the association of the static media object to a display area is based on information comprised in a file delivery table instance of the delivery session.

33. The computer-readable medium according to claim 32, further storing instructions that, when executed by the processor, cause the provision of location information of the static media object and of the static media object's identifier to the receiving entity within a file element of a file delivery table instance of the delivery session.

34. The computer-readable medium according to claim 33, further storing instructions that, when executed by the processor, cause storing each received static media object, its object identifier, its associated display area identifier and its display period in a cache at the receiving entity.

35. The computer-readable medium according to claim 33, further storing instructions that, when executed by the processor, cause determining which of a plurality of static media objects associated to one display area is displayed in the display area based on the display period of each of the plurality of static media objects.

36. The computer-readable medium according to claim 28, wherein the display period indicates the point in time at which displaying the static media object is started and a display duration for the static media object or the point in time at which displaying the static media object is stopped.

37. A computer-readable medium for storing instructions that, when executed by a processor, cause the processor to initiate the transmission of a static media object delivered from a transmitting entity to a receiving entity employing a delivery session according to the FLUTE (File Delivery over Unidirectional Transport) protocol by:
providing a static media object and its timing information to the receiving entity, wherein the timing information is provided to the receiving entity within a file element of a file delivery table instance of the delivery session.

38. The computer-readable medium according to claim 33, further storing instructions that, when executed by the processor, cause an association of an object identifier of each static media object to be delivered to the receiving entity in the delivery session to a display area identifier, and a transmission of application semantics describing the delivery session and at least one display area for displaying a static media object, wherein the semantics provide an association of each display area to a display area identifier,
wherein the display area is identified by the association of the static media object's identifier to a display area identifier.

39. The computer-readable medium according to claim 37, further storing instructions that, when executed by the processor, cause a dynamic association of the static media object to an object identifier.
